(19) United States
(12) Patent Application Publication
(10) Pub. No.: US 2015/0015142 A1
(43) Pub. Date: Jan. 15, 2015

(54) LED LIGHT BULB WITH LEDS MOUNTED ON ANGLED CIRCUIT BOARD

(71) Applicant: Huizhou Light Engine Limited, Huizhou City (CN)

(72) Inventors: Tin Po Flavio Chu, Hong Kong (CN); Kam Wah Siu, Hong Kong (CN); Vincent Tsz Yeung Li, Hong Kong (CN); Wa Hing Leung, Hong Kong (CN)

(73) Assignee: Huizhou Light Engine Limited, Huizhou City (CN)

(21) Appl. No.: 13/939,957

(22) Filed: Jul. 11, 2013

(51) Int. Cl. F21K 99/00; F21V 29/00

(52) U.S. Cl. CPC F21K 9/1355; F21K 9/90; F21V 29/22
USPC 315/51; 445/23

(57) ABSTRACT

An LED light bulb has a lamp base for a lamp socket, a heat sink, and a globe. Within the globe on the heat sink is a printed circuit board having tabs or legs projecting from the circuit board. The tabs or legs have one or more LEDs mounted thereon and are angled relative to the circuit board so as to be directed away from the axis of the light bulb. the circuit board may either be ring-shaped with inwardly extending tabs, or may have outwardly extending tabs. Methods of making such LED light bulb and methods of distributing light from the LED light bulb, which involves directing light output by a plurality of LEDs in a plurality of radially outward directions relative to an axis of the light bulb, are also disclosed herein.

### TECHNICAL FIELD OF THE INVENTION

The present invention relates generally to a light bulb using light emitting diodes (LEDs) as a light source, and more particularly to an LED light bulb configured to replace an incandescent or other light bulb.

### BACKGROUND OF THE INVENTION

Incandescent light bulbs have been widely used for years, but energy concerns have led to lower energy light sources being developed. One such low energy light source is a light emitting diode, commonly referred to as an LED. While incandescent light bulbs emit light relatively evenly over a wide angle, LEDs generally emit light at a narrower angle. It would be beneficial to provide an LED light source that emits light relatively evenly over a wide angle.

Light bulbs that use LEDs as the light emitting components in the bulb have become more popular. Advancements in chip technology, heat sinking design, and power supply unit design have made LED bulbs more energy efficient and resulted in the LED bulbs lasting much longer than traditional light sources such as incandescent bulbs and CFL (compact fluorescent) bulbs. However, LED bulbs still fall short of the traditional light sources in terms of the shape of the radiation pattern. LEDs that are used as components in the light bulb emit light in a directional way, which means that most light is emitted toward the direction that the LED faces. This characteristic limits the light dispersion or FWHM (Full Width Half Maximum) angle of an LED bulb.

The most common approach to increase LED bulb FWHM angle is by using a diffusive globe. However, even with a diffuser globe the FWHM angle is still below 200 degrees. By contrast, incandescent bulbs and CFL bulbs are considered omni-directional light sources which emit their light over a wide angle, generally having a FWHM angle of greater than 300 degrees.

There is a great demand of omni-directional LED bulbs. The U.S. Energy Star program has defined omni-directional lights as those having a FWHM angle of greater than 270 degrees.

Several solutions have been introduced to address this issue. Some rely on specially design diffusers, reflectors, and special placement of the LED Printed Circuit Board (PCB). All these solutions increase the cost and complexity of the light bulb product, make it less acceptable to the market and more difficult to mass produce.

There is a need for an LED light bulb that is cost-effective, simple and complies with the Energy Star definition of an omni-directional light source (i.e., having a FWHM angle of greater than 270 degrees).

An example of a prior art LED light bulb is shown in FIG. 1. The light bulb 10 has a base 12 for connection to a light socket. The base 12 may be threaded or configured to connect to some other socket configuration for retrofit into a known socket. A housing portion 14 encloses electrical conductors, and possibly drive circuit elements, and provides a heat sink to dissipate heat from the LEDs. A globe 16 of transparent material such as glass or plastic is mounted on the housing 14. A printed circuit board 18 is mounted within the globe 16. The circuit board 18 has a flat shape and has mounted thereon a plurality of LEDs 20, each of which face upward on the surface of the circuit board 18.

In FIG. 2, the light distribution graph of light intensity emitted by the light bulb of FIG. 1 is shown at 22. The light graph shows that the FWHM light output of the light bulb 10 is less than 200 degrees.

### BRIEF SUMMARY OF THE INVENTION

In light of the above, there exists a need to further improve the art.

In accordance with an embodiment of the present invention, an LED light bulb that includes a circuit board mounted on a heat sink. The circuit board has a body from which one or more LED mounting portions extend in a plurality of radial directions. One or more LEDs are mounted on the one or more LED mounting portions. The LED mounting portions are each disposed at an angle to the body of the circuit board, the angle being such that the LEDs each face in a direction that includes a radial component in a radially outward direction relative to an axis of the circuit board.

The LED mounting portions may extend radially inward from the body of the circuit board or may extend radially outward from the body of the circuit board. The mounting portions may be disposed at either a positive or negative angle relative to the body of the circuit board.

In accordance with another embodiment of the present invention, a light bulb, comprising a lamp base configured for electrical connection to a lamp socket; a heat sink having a first portion connected to the lamp base and a second portion, the second portion including a mounting surface opposite the first portion, the heat sink including a mounting rim encircling the mounting surface; a circuit board mounted on the mounting surface, the circuit board including a planar circuit board body mounted in thermal contact with the mounting surface, a plurality of tabs extending from the planar circuit board body, the tabs extending in a plurality of directions from the planar circuit board body, the tabs being disposed at an angle relative to the planar circuit board body; electrical connecting elements connected between the lamp base and the circuit board; LEDs mounted on the tabs and electrically connected to the planar circuit board body so as to emit light from the LEDs in a plurality of directions having an outward component relative to the circuit board; and a globe having a mounting opening affixed to the mounting rim of the heat sink.

In accordance with a further embodiment of the present invention, the circuit board comprises a central planar circuit board body, and wherein the plurality of tabs extend in outward directions from the central planar circuit board body.

In accordance with a further embodiment of the present invention, the circuit board comprises a planar circuit board body having an opening formed therein, and wherein the plurality of tabs extend in inward directions at the opening in the planar circuit board body.

In accordance with a further embodiment of the present invention, the mounting surface is substantially planer, the tabs being disposed at an angle to the planar circuit board body so as to be free of the mounting surface.

In accordance with a further embodiment of the present invention, the mounting surface of the heat sink includes a raised central portion and angled segments adjacent the raised central portion, the tabs of the circuit board being mounted in thermal contact with the angled segments.

In accordance with a further embodiment of the present invention, the planar circuit board body is mounted on the raised central portion of the heat sink.

In accordance with a further embodiment of the present invention, the tabs extend radially outward from the planar circuit board body.

In accordance with a further embodiment of the present invention, the planar circuit board body encircles the raised central portion of the heat sink.

In accordance with a further embodiment of the present invention, the tabs extend radially inward from the planar circuit board body.

In accordance with a further embodiment of the present invention, the planar circuit board body and the tabs disposed at angles to the planar circuit board body are formed of a single piece circuit board.

In accordance with a further embodiment of the present invention, the plurality of tabs are each of a same size and shape.

In accordance with a further embodiment of the present invention, at least one of the plurality of tabs are of differing at least one of size and shape than others of the plurality of tabs.

In accordance with a further embodiment of the present invention, each of the plurality of tabs is bent as a same angle relative to the planar circuit board body.

In accordance with another embodiment of the present invention, a method of making an LED light bulb, comprising mounting a plurality of LEDs on radially projecting tabs of a circuit board, the circuit board having a circuit board body; bending the tabs at an angle to the circuit board body so that the LEDs face in a direction having a outward component relative to the circuit board; mounting a circuit board on a heat sink within a globe of the LED light bulb, the circuit board body being mounted in thermal contact with the heat sink; and mounting a globe over the LEDs and circuit board.

In accordance with another embodiment of the present invention, a method of distributing light from an LED light bulb, comprising directing light output by a plurality of LEDs in a plurality of substantially radially outward directions relative to an axis of the light bulb, the plurality of LEDs being mounted on a single piece circuit board on angled tabs extending radially from a body of the circuit board; and electrically connecting the plurality of LEDs to power via the single circuit board.

In accordance with another embodiment of the present invention, an LED light bulb, comprising a power supply connection; a heat sink having a mounting surface; a circuit board having a planar body mounted in thermal contact with the mounting surface of the heat sink, the circuit board having a plurality of tabs extending radially from the planar body, the tabs being bent at an angle to the planar body; a plurality of LEDs mounted on the tabs so as to have light emitting faces of the LEDs directed in directions having substantially radially outward components relative to an axis of the circuit board; the power supply connection being connected to the circuit board and to the LEDs to power the LEDs; and a globe mounted over the LEDs.

In accordance with a further embodiment of the present invention, the planar body of the circuit board is ring-shaped and the tabs extend radially inward.

In accordance with a further embodiment of the present invention, the planar body of the circuit board is a central circuit board portion and the tabs extend radially outward.

In accordance with a further embodiment of the present invention, at least one LED is mounted on the planar body of the circuit board.

### BRIEF DESCRIPTION OF THE DRAWINGS

FIG. 1 is a top perspective view of an LED light bulb of the prior art;

FIG. 2 is a graph showing light dispersion angles for the light bulb of FIG. 1;

FIG. 3 is a side elevational view of an LED light bulb according to a first embodiment of the present invention;

FIG. 4 is an enlarged, fragmentary top perspective view of the light bulb of FIG. 3;

FIG. 5 is a top perspective view of the LED light bulb of FIG. 3;

FIG. 6 is a top perspective view of a circuit board of the LED light bulb of FIG. 3;

FIG. 7 is an enlarged, fragmentary side view of the circuit board of FIG. 3;

FIG. 8 is a diagram of a light path from an LED element of FIG. 3;

FIG. 9 is a top perspective view of a second embodiment of an LED light bulb of the invention;

FIG. 10 is a fragmentary cross-sectional view of the light bulb of FIG. 9;

FIG. 11 is an exploded perspective view of the light bulb of FIG. 9;

FIG. 12 is a top perspective view of a circuit board of the light bulb of FIG. 9;

FIG. 13 is a side elevational view of the circuit board of FIG. 12;

FIG. 14 is a top perspective view of an LED light bulb according to a third embodiment;

FIG. 15 is a fragmentary cross-sectional view of the light bulb of FIG. 14;

FIG. 16 is an exploded perspective view of the light bulb of FIG. 14;

FIG. 17 is a top perspective view of a circuit board of the light bulb of FIG. 14;

FIG. 18 is a side elevational view of the circuit board of FIG. 14;

FIGS. 19A, 19B and 19C are a comparison of three widths of circuit boards, showing for each a schematic side view, a schematic illustration of light paths, and a dispersion chart;

FIGS. 20A, 2013 and 20C are a comparison of three heights of circuit boards, showing for each a schematic side view, a schematic illustration of light paths, and a dispersion chart;

FIG. 21 is a schematic illustration of a light bulb of a preferred embodiment along with two dispersion charts;

FIG. 22 is two dispersion charts for a prior art light bulb;

FIG. 23 is an enlarged top perspective view of a printed circuit board according to another embodiment;

FIG. 24 is an enlarged top perspective view of a printed circuit board according to a further embodiment; and

FIG. 25 is an enlarged top perspective view of a printed circuit board according to yet a further embodiment.

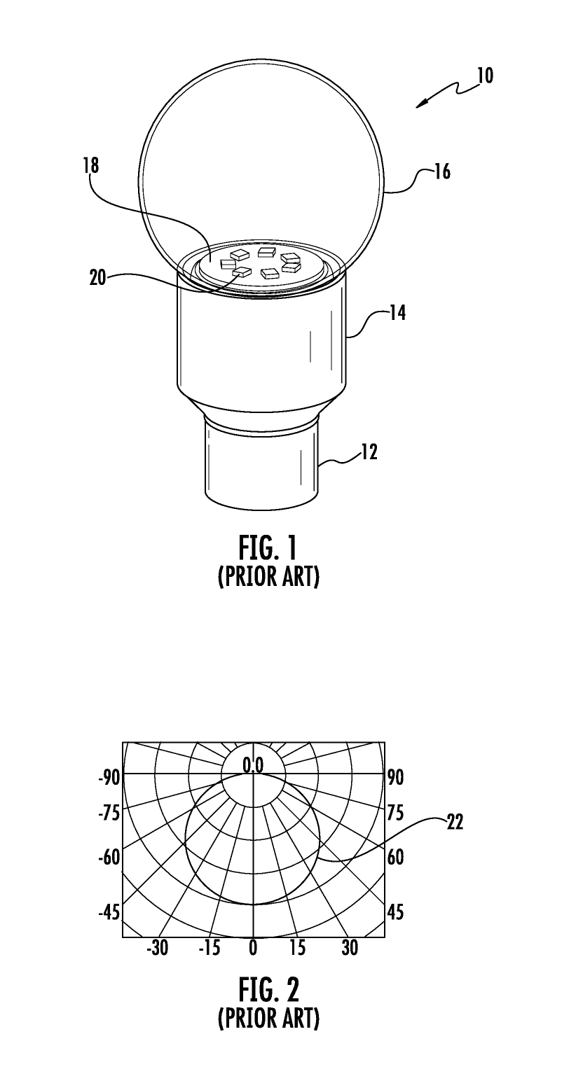

### DETAILED DESCRIPTION OF THE INVENTION

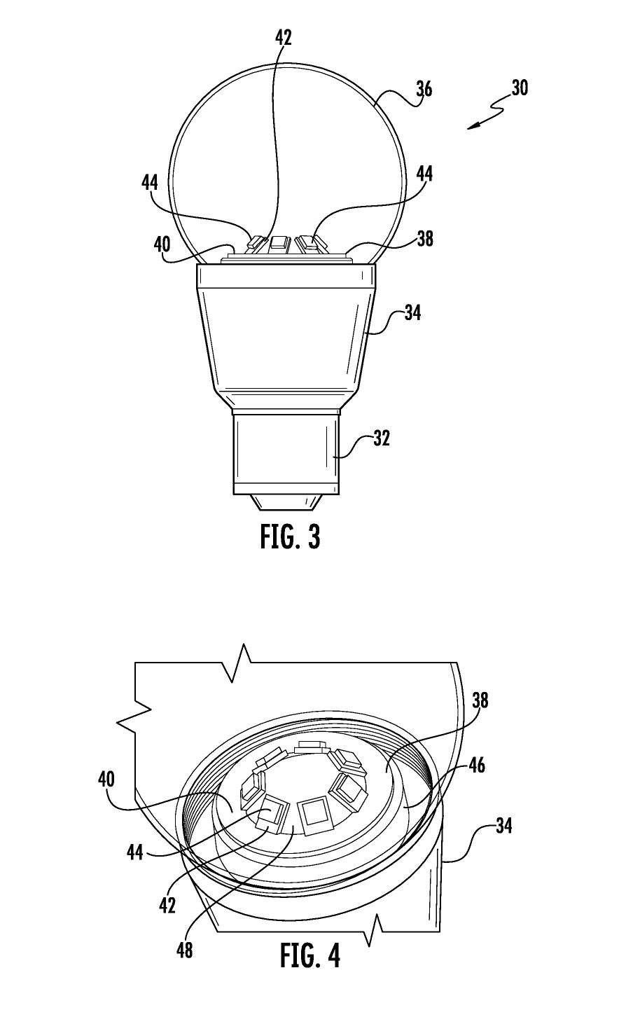

In FIG. 3 is a first preferred embodiment of an LED light bulb 30. The light bulb 30 has a base 32 for mounting in a standard light socket. The base, shown as a smooth cylinder for simplicity, may be threaded or smooth, have locking projections, connector pins, or other mounting and/or electrical connecting structures, as will be understood by those of skill in this art. For example, the base 32 may include sidewardly projecting pins for mounting in a bayonet connection socket, or may be threaded for mounting in a threaded socket. Other connections and mountings are possible.

A housing 34 connected to the base 32 generally replicates the shape of a conventional incandescent light bulb in the illustrated embodiment and serves as a heat sink as well as an enclosure for electrical conductors. Drive circuits, circuit components or other features may be provided in or on the heat sink. A globe 36 is connected to the housing 34 and provides a clear or translucent body through which light of the LEDs is emitted. The globe 36 may serve as a diffuser in a preferred embodiment although a clear globe is also possible. The globe 36 may be provided in a variety of colors.

Within the globe 36 is a printed circuit board (PCB) 38. The circuit board 38 has a generally planar portion 40 mounted to the housing 34 and a plurality of tabs 42 that are shaped to angle upwardly from the planar portion 40. Each tab 42 has mounted thereon an LED 44. The LEDs 44 face different respective directions. In the illustration, the LEDs face outwardly and include a radial outward component for light emitted by the LED relative to the light bulb.

In FIG. 4, the housing 34 includes a central pedestal portion 46 on which the circuit board 38 is mounted. The planar portion 40 of the circuit board is seated on the pedestal portion 46, thereby transferring heat from the LEDs 44 to the heat sink of the housing 34. The planar portion 40 if the first embodiment has a circular or ring-shaped configuration with a central opening. Other shapes are possible for the circuit board including a circuit board having an opening formed therein that has the tabs extending into the opening. The tabs 42 project from the outer ring-shaped portion 40 toward the central opening. In the illustrated embodiment, the tabs 42 extend radially inward toward the axis of the circuit board. Gaps 48 are formed between the tabs 42. The tabs 42 of the illustrated embodiment are generally rectangular in shape, although other shapes are possible. The rectangular tabs 42 result in wedge-shaped gaps between the tabs.

In the illustrated embodiment, each tab 42 is at substantially the same angle from the planar portion 40, although different angles for one or more of the different tabs are also possible. The tabs 42 may be formed by shaping the circuit board 38 as a planar element with the tabs 42 in the plane of the planar portion and then bending the tabs 42 at the desired angle.

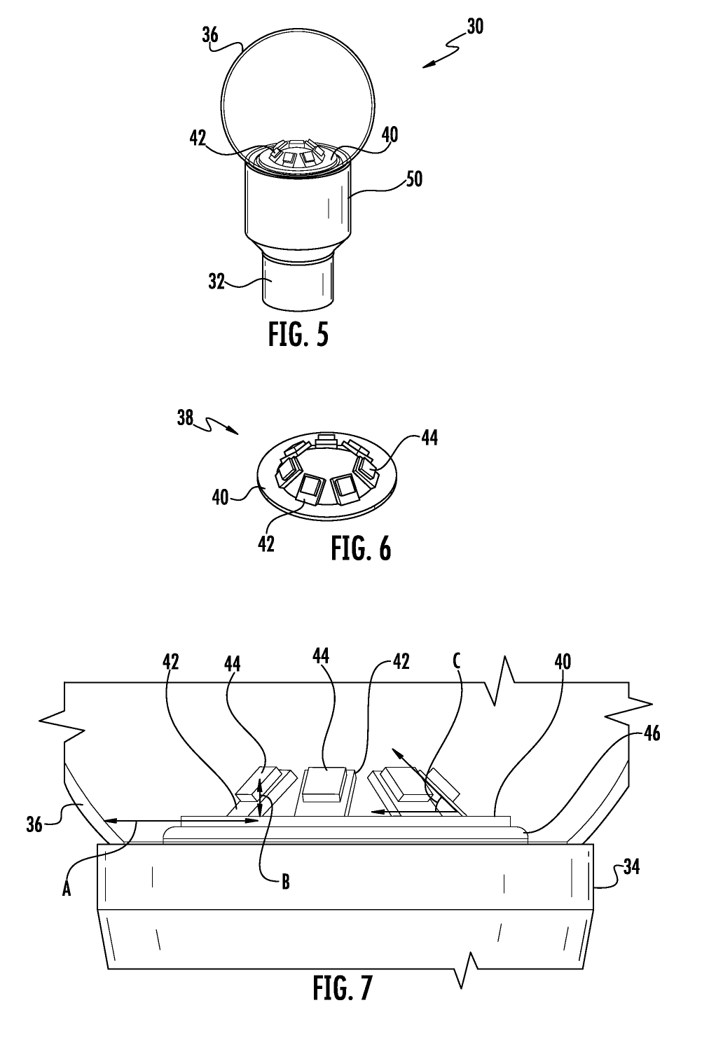

FIG. 5 shows the LED bulb 30 with a cylindrical housing 50 instead of the conical housing of FIG. 3. Other shapes of housings and/or heat sinks are possible within the scope of this invention. The tabs 42 on which the LEDs are mounted are angled or bent at approximately 45 degrees with respect to the planar portion 40. The angled or tilted LEDs direct their light emissions in radially outward directions, which result in a wider dispersion angle for the light bulb 30 compared to LED bulbs with LEDs mounted on a plane. For example, the FWHM illumination angle for the illustrated bulb is approximately 280 degrees.

FIG. 6 shows the circuit board 38. The circular or ring-shaped overall shape of the illustrated embodiment can be changed to other shapes as desired. The circuit board need not form a complete enclosure around a central opening, but may form only portion of a perimeter about an opening. The tabs 42 are generally rectangular and are of approximately the same size and shape, as shown, but it is within the scope of the present invention to provide tabs of mutually different shapes and/or sizes. A single LED 44 is provided on each tab 42. Of course, it is possible that a plurality of LEDs may be provided on one or more tabs 42.

In the enlarged view of FIG. 7, it is apparent that light emitted from the face of the LEDs 44 is directed outward and upward from the bulb. This is a result of the LEDs facing in directions that have an outward radial component with respect to the axis of the circuit board and in radial directions with reference to the axis of the light bulb 30. In the illustrated embodiment, each LED has a different outward radial light emitting direction. An omni-directional bulb is thereby provided.

Three factors influence the final FWHM light output of the light bulb, as shown by the arrows in FIG. 7. These include (A) the distance from the center of the LED to the outer edge of the heat sink or globe; (B) the height of the center of the LED from the top surface of the heat sink 46; and (C) the tilt angle of the LED from the planar circuit board. These factors can be changed in different embodiments.

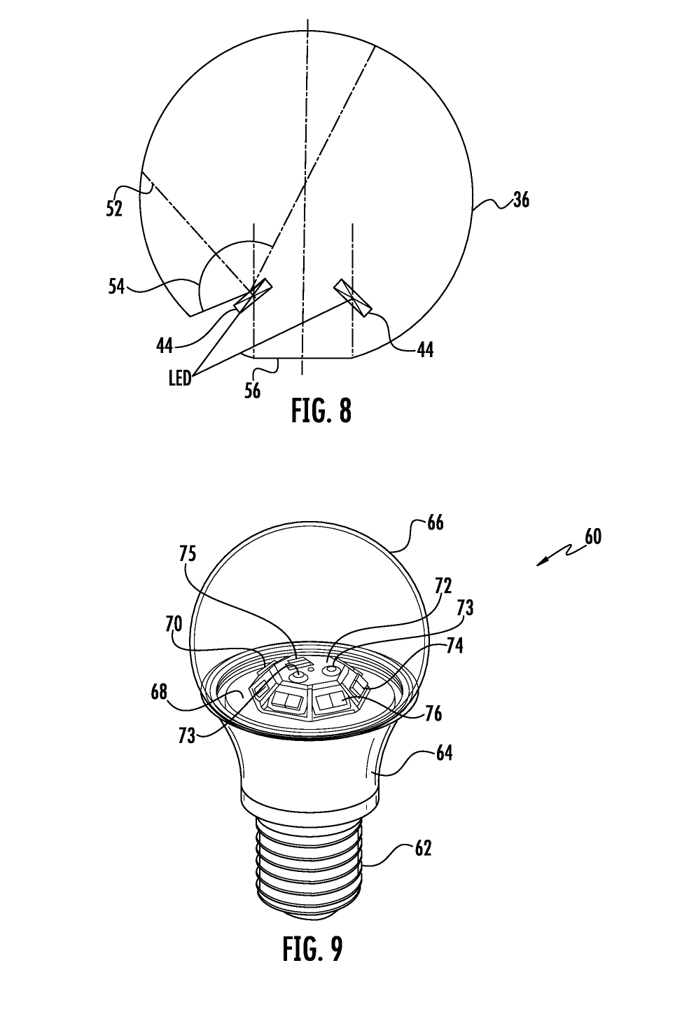

FIG. 8 is a schematic representation of the globe 36 with two LEDs 44 at tilted angles relative to the planar circuit board. A line 52 indicates a maximum intensity of the LED 44. An angle 54 indicates a beam width of the LED 44. A distance 56 indicates the spacing between the centers of the LEDs 44. As can be seen, as a result of the tilt angle and the beam width, portions of the light is emitted below horizontal as well as beyond the axis of the bulb.

The resulting LED light bulb is compatible with existing LED and non-LED bulbs, has a low cost to manufacture and provides a light emission output that is compliant with Energy Star omni-directional beam pattern requirements.

The LED circuit board has bent legs or tabs extending therefrom in either radially inward or radially outward directions. The radial extension of the legs or tabs may be relative to an axis of the circuit board and/or relative the axis of the light bulb. The LEDs are located on multiple legs or tabs of a traditional metal printed circuit board. Each leg is bent by a die punching process or similar method, so that each LED is tilted at a predetermined angle relative to the base plate portion of the circuit board. The tilted LEDs result in more peripheral light being transmitted from the globe. Light is also reflected internally within the globe in addition to the transmitted light. Some of the reflected light will exit the globe and contribute to the amount of peripheral light emitted by the bulb.

The globe may be made of optically diffusive material, so that light is scattered as it exits the globe. The level of scattering can be changed by providing different levels of optical diffusion in the globe. The direction of light scatter can depend on the shape of the globe. As such, globes of different shapes and different degrees of diffusion may be provided. In a preferred embodiment, the globe shape is provided to increase peripheral light distribution.

Particular features of this and other embodiments include a globe of glass or plastic that is either transparent or translucent and can be of any shape profile. The globe may be of a size that is up to 80 percent of the total length of the overall bulb. The lower edge of the globe is secured to the housing or heat sink. The heat sink is formed of metal or plastic. In a first embodiment, the top surface of the heat sink is flat and coupled to the flat portion of the circuit board. The lower end of the heat sink is connected to the lamp socket.

The circuit board of one example is a metal type circuit board with a substrate of aluminum or copper. Other circuit boards may be used as well, including glass-reinforced epoxy laminated printed circuit boards, for example, FR-4 circuit boards. The preferred circuit board is in a single piece with two distinct sections; a flat section that is coupled to the heat sink and is the base surface of the circuit board prior to bending of the tabs, and a second section formed by the bent tabs. Electrical connections are made to the circuit board from connectors within the heat sink, and electrical connections are provided to each LED mounting tab. The tabs or legs are tilted at angles that may range from 90 degrees to −90 degrees. The tilted or bent circuit board has two or more LEDs. The LEDs face outward relative to the axis of the circuit board and the bulb.

It is within the scope of this invention to provide a circuit board that is a shape other than a circular shape, for example, of a polygonal shape, whether symmetrical or asymmetrical. The tabs may extend symmetrically from the planar portion of the circuit board or may extend asymmetrically. The tabs may extend in radial directions from the circuit board or may extend in other directions that are not radial. The LEDs may be provided on every tab or one or more tabs may be provided that lack LEDs. More than one LED may be provided on one or more of the tabs. The LEDs may be provided on the planar portion of the circuit board in addition to being mounted on the tabs. The LEDs may be surface mount components, or other type of components. The tabs may be formed in the same plane as the planar portion and subsequently shaped to the tilted position, such as by bending or other forming process. Alternately, the circuit board may be formed with the tabs at the tilted positions.

The circuit boards include additional features, such as circuit elements, contact locations and mounting openings, some of which are shown in the drawings but are not described in further detail herein. Such features will be understood by those of skill in this art.

A second embodiment is shown in FIG. 9, in which the tilt of the LED tabs or legs is a negative angle. In particular, an LED light bulb 60 includes a lamp base 62 to which is connected a housing or heat sink 64, to which is connected in turn a globe 66. On a top surface 68 of the heat sink 64 is a circuit board 70 that has a central portion 72 and peripheral legs or tabs 74. The tabs 74 have one or more LEDs 76. The legs or tabs 74 are bent at an angle relative to the central portion 72, here at a negative angle so that the tabs 74 and LEDs 76 are below the central portion 72 relative to the orientation of the bulb as illustrated. A pair of rivets or screws 73 are fastened at the central portion 72 to secure the circuit board 70 in place. An electrical connector 75 provides the electrical connection to the circuit board from electrical conductors within the housing 64.

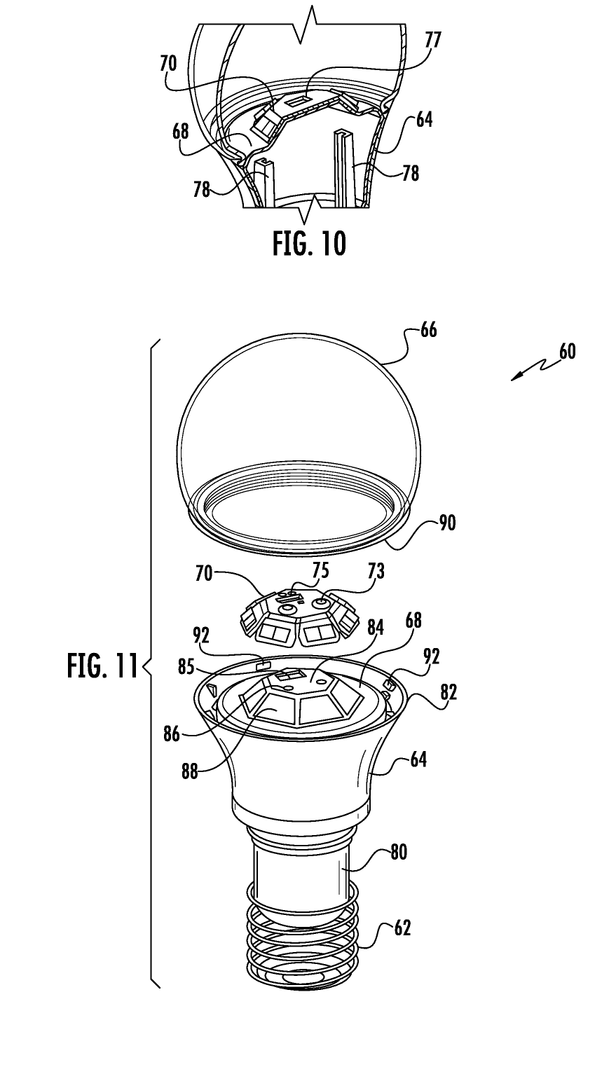

Turning to FIG. 10, the heat sink 64 has the top surface 68 shaped to conform to the shape of the bent circuit board 70. In particular, a central portion of the top surface 68 is raised to lie against the underside of the circuit board, for example, for effective heat transfer. Within the heat sink 64 is a pair of slotted circuit board holders 78 that hold a circuit board (not shown) which contains LED drive circuitry and which provides an electrical connection from the lamp base 62 to the circuit board 70. An opening 77 is shown in the central portion of the circuit board where the electrical connector 75 is mounted that connects the circuit board held in the holders 78 to the circuit board 70 on which the LEDs are mounted.

FIG. 11 provides an exploded view of the light bulb 60. The threaded lamp base 62 fits over a lower extension 80 of the heat sink 64. The upper portion of the heat sink 64 has a projecting rim 82 to which the globe 66 is affixed. Within the projecting rim 82 is the top surface 68 of the heat sink. The top surface 68 has a central portion 84 that is raised to contact the underside of the circuit board 70. Openings 86 for receiving the screws or rivets 73 are provided on the raised portion 84. An opening 85 is also provided in the central portion 84 through which extends the electrical connector 75. Around the central portion 84 are provided shaped, angled portions 88 that correspond in shape and angle to the tabs or legs 74 and thereby provide a contact surface for contacting the undersides of the tabs 74. The printed circuit board 70 has the same number, shape, and angle of tabs 74 as the angled portions 88 of the heat sink 64.

The globe 66 has a lower rim 90 that fastens to mounting elements 92 in the projecting rim 82. Adhesive, welds, threaded mounting, friction fit or other securing means may hold the components of the light bulb 60 together.

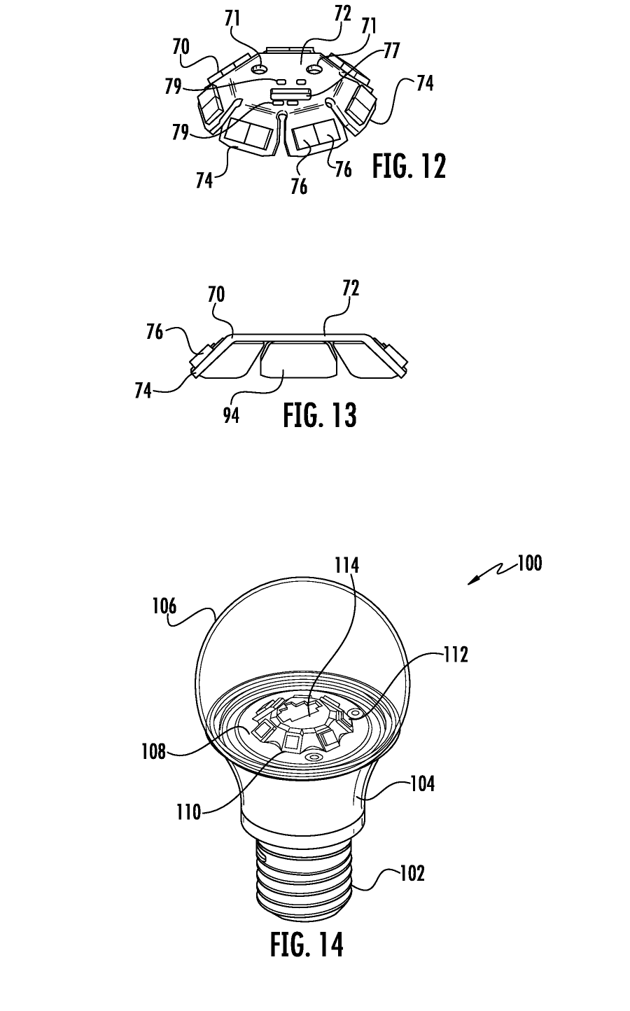

In FIG. 12, the circuit board 70 has the central portion 72 that is provided with openings 71 for the screws or rivets 73, the opening 77 for the electrical connector 75, and electrical contact sites or solder pads 79 for electrical connection to the circuit containing the LEDs. Electrical connectors and circuit components as are necessary to operation of the light bulb are provided in each embodiment, as will be understood by those of skill in the art. Around the perimeter of the central portion 72 is provided the tabs or legs 74 that are bent at an angle relative to the central portion 72. The LEDs 76 are provided on the tabs 74; in this example, two LEDs 76 are provided on each tab 74. It is also possible that one LED may be provided on each tab 74 or that some tabs may have one LED and others have more than one. The bent tabs 74 result in the LEDs being directed or facing outwardly relative to the axis of the bulb and of the circuit board. The tabs and LEDs are generally in the same arrangement as in the first embodiment; the difference being that the planar portion of the circuit board of one embodiment is provided around the perimeter of the tabs in the form of a ring and the other has the planar circuit board at the center of the tabs.

In FIG. 13, the undersides of the tabs 74 are provided with contact surfaces 94 that provide thermal contact with the surfaces 88 of the heat sink 64. The contact surfaces 94 may be provided with thermal transfer material, adhesive, or other material if desired.

The second embodiment with the central portion of the circuit board from which extends the tabs has been shown mounted on a shaped heat sink that contacts the underside of the angled tabs. It is also foreseen that the first embodiment with the ring shaped circuit board and the inwardly extending tabs may be mounted on a shaped heat sink that has angled surfaces in contact with the undersides of the tabs. The central portion of the heat sink of the first embodiment may be raise or not as desired.

FIG. 14 shows a third embodiment of an LED light bulb 100 having a base 102, a heat sink 104, a globe 106 and a printed circuit board 108 with bent tabs 110 on which are provided LEDs 112. The circuit board 108 has a central opening into which extend the tabs 110, similar to the first embodiment. The heat sink 104 has a raised central portion 114 with shaped angled sides on which the tabs 110 are positioned, similar to the second embodiment.

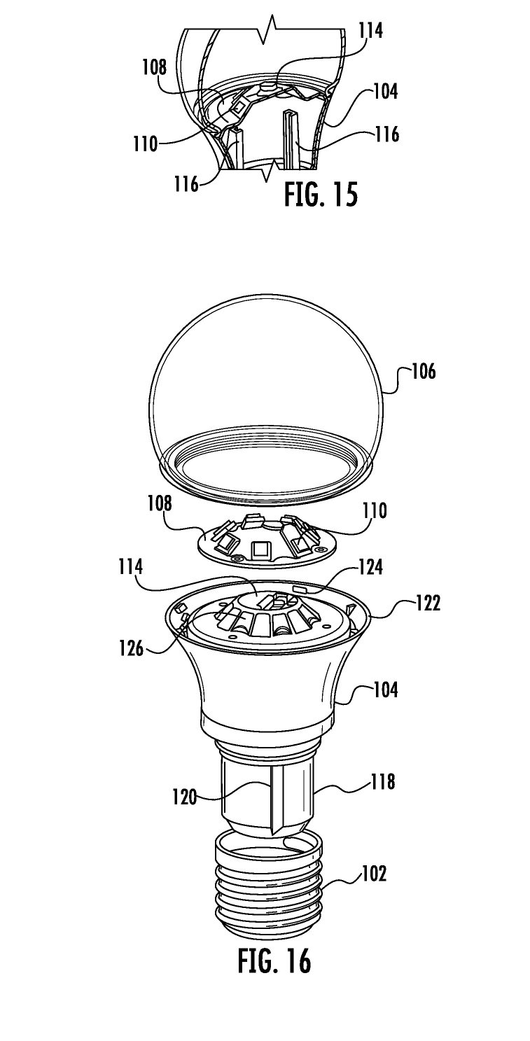

FIG. 15 shows the shape of the heat sink 104 with its central raised portion 114 on the sides of which are mounted the bent tabs 110. The printed circuit board 108 surrounds the central portion 114 of the heat sink 104 and is mounted on a flat lower portion thereof. Slotted circuit board holders 116 are provided within the heat sink 104.

With reference to FIG. 16, the exploded view of the third embodiment has the lamp socket base 102 removed from a lower portion 118 of the heat sink 104. A slot 120 is provided on the lower portion 118 for alignment purposes. The opposite end of the heat sink has a rim 122 that includes fastening elements 124 for securing the globe 106 in place. The raised central portion 114 has side panel portions 126 shaped to receive the bent tabs 110 of the circuit board 108. The raise central portion 114 may include circuit elements and/or electrical connection elements.

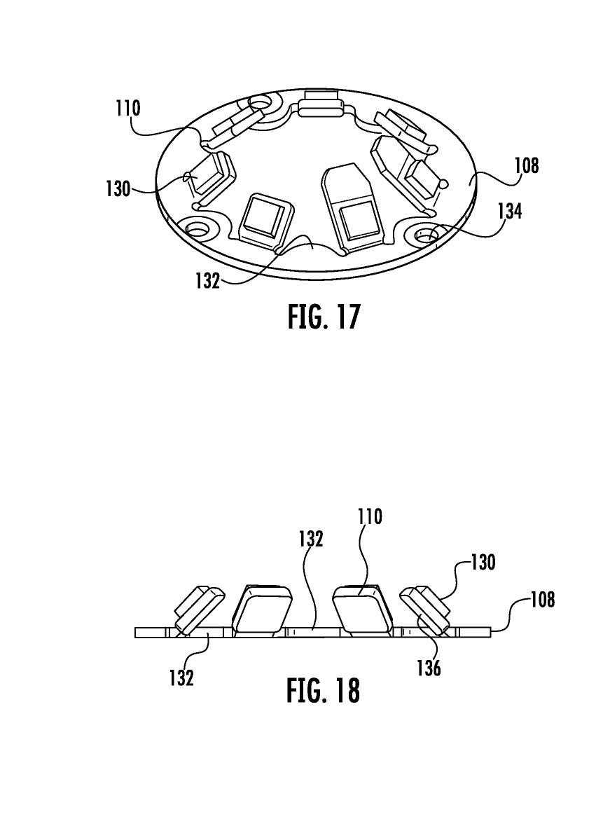

In FIG. 17, the printed circuit board 108 has a central opening into which extend the tabs 110. The tabs 110 have LEDs 130 on each bent tab so that the LEDs are directed away from the axis of the circuit board and away from the axis of the light bulb. The tabs 110 are of different shapes rather than being all the same shape, with some tabs being longer and others being shorter. The circuit board 108 has rounded projections 132 between each of the tabs 110. Some of the rounded projections 132 have openings through which connectors may be inserted for securing the circuit board 108 to the heat sink 104.

FIG. 18 shows that the circuit board 108 has the upwardly angled tabs 110 extending inwardly toward the central axis of the circuit board and bent upward to direct the light from the LEDs in a radially outward direction. The tabs 110 have underside surfaces 136 that bear against the surfaces of the raised central portion of the heat sink 104. The underside surfaces 136 can be affixed to the heat sink 104.

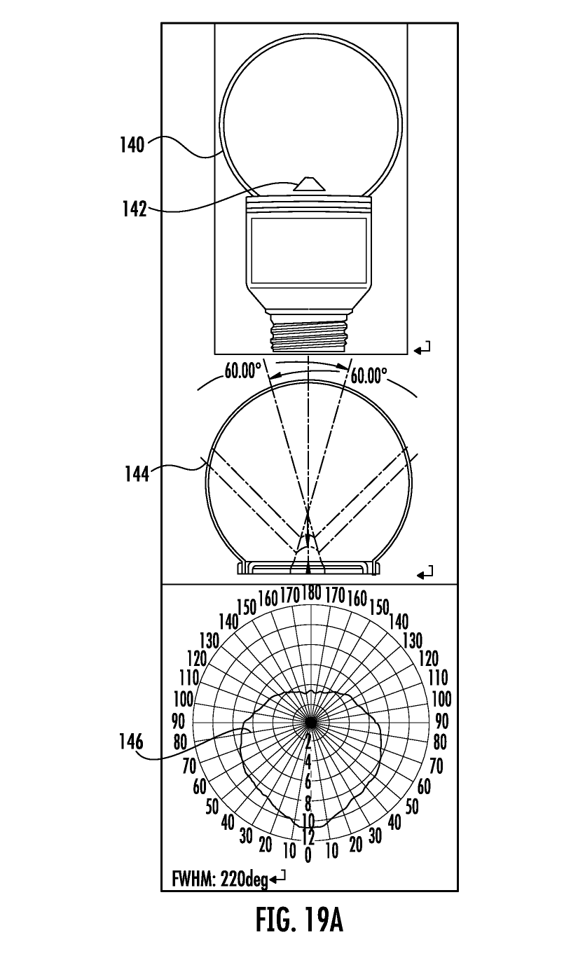

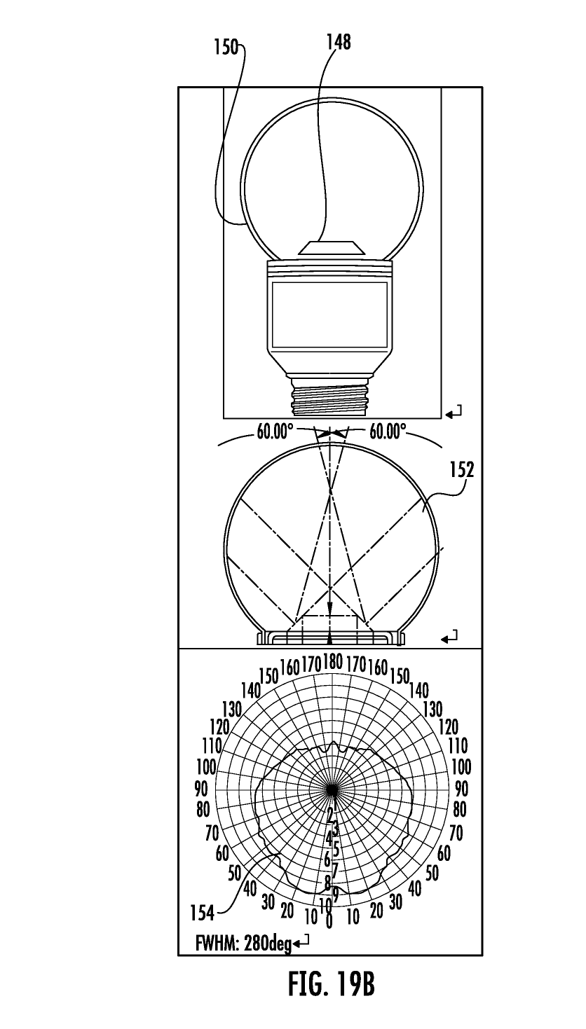

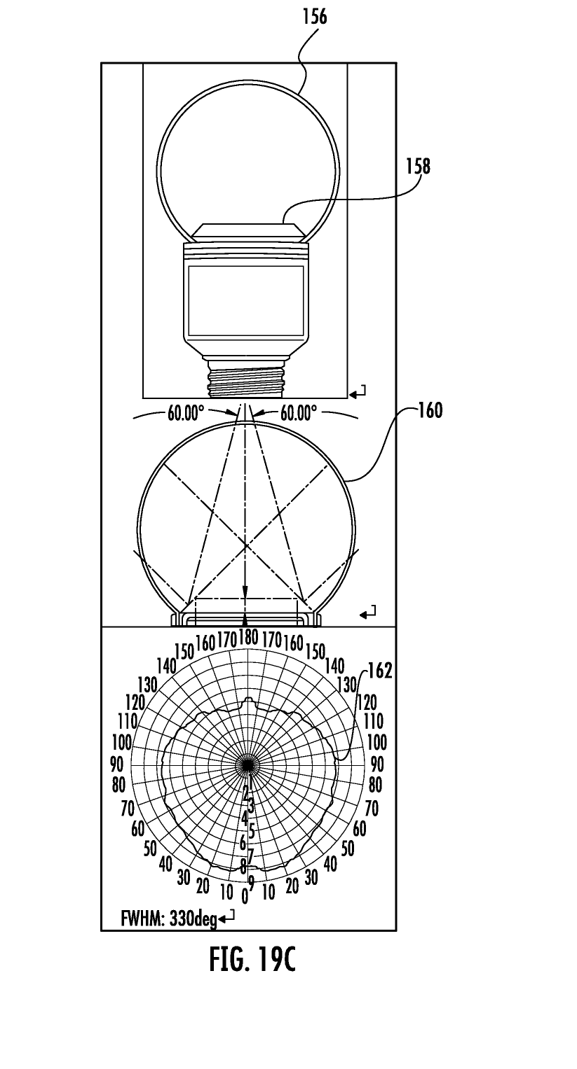

In FIGS. 19A, 19B, and 19C, the effect of changing the distance between the angled LED elements is considered in terms of light dispersion. The light bulbs shown here are provided with diffuser globes. A first light bulb 140 is provided with angled LEDs 142 that are closely positioned near one another. In a diagram 144, the light angles are shown, which result in a light distribution curve 146. In a second light bulb 150, the LEDs 148 are spaced a medium distance apart. In the diagram 152, the angles show less overlap at the top of the bulb compared to diagram 144. The chart 154 shows an improved dispersion curve angle. The third light bulb 156 has the LEDs 158 spaced widely apart. The overlap angle at the top of the bulb lies outside the globe. The distribution curve 162 is shown.

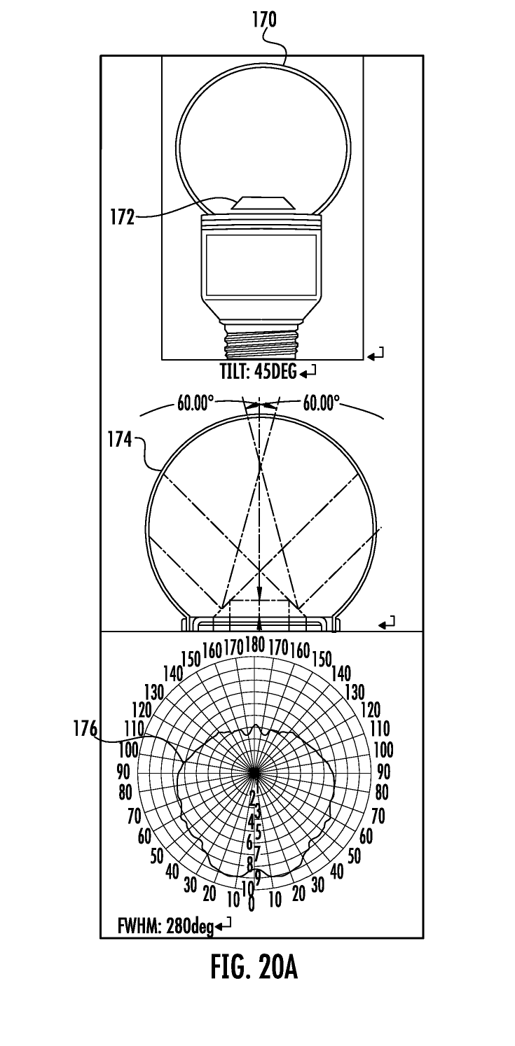

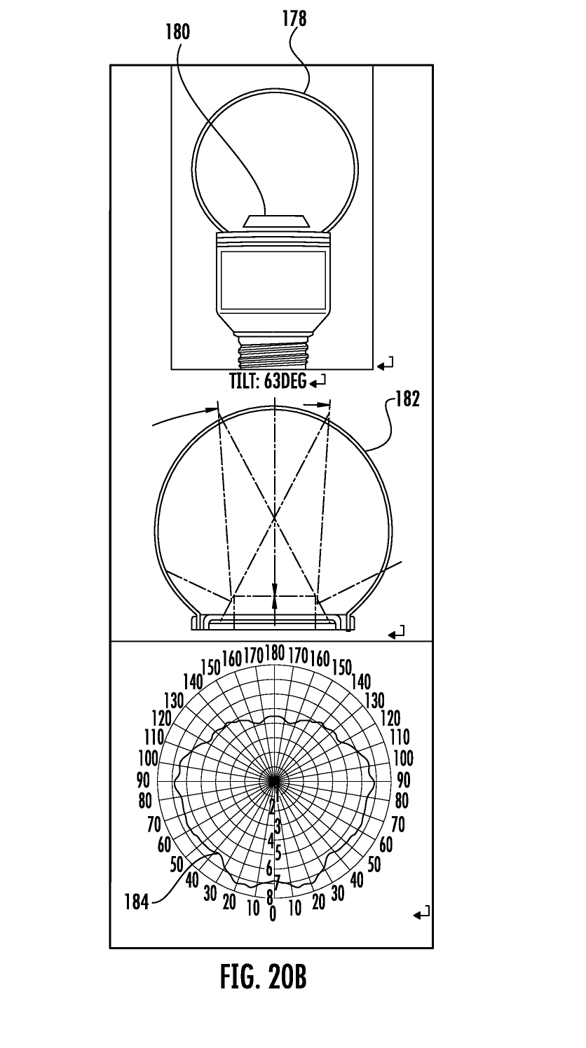

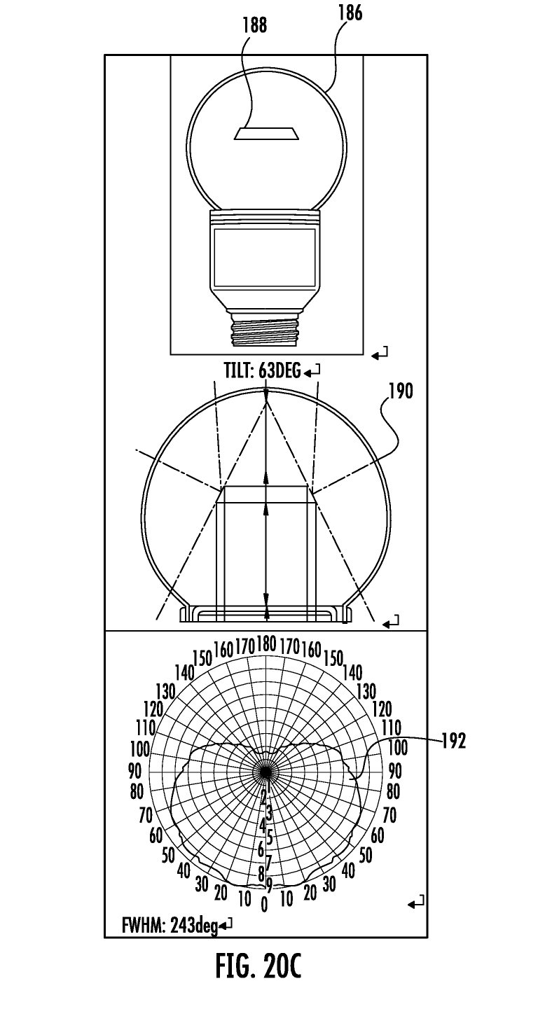

FIG. 20 shows the effect of changing the angle of the LEDs and the effect of changing the position of the LEDs within the light bulb. A first light bulb 170 has LEDs 172 tilted at a 45 degree angle. The diagram of light angles 174 shows the direction of the light emitted by the LEDs 172. A dispersion diagram 176 is provided. In a second bulb 178, the LEDs 180 are tilted at a 63 degree angle. The diagram 182 shows significantly different light distribution angles as a result. The light dispersion curve 184 changes as well. In a third light bulb 186, the LEDs 188 are raised to a position about half way up the globe or more. The angles in the diagram 190 again are dramatically different. The light dispersion curve 192 changes shape dramatically.

The foregoing show that the angle, spacing and height of the angled LEDs changes the light dispersion curves. Varying these parameters is within the scope of the present invention.

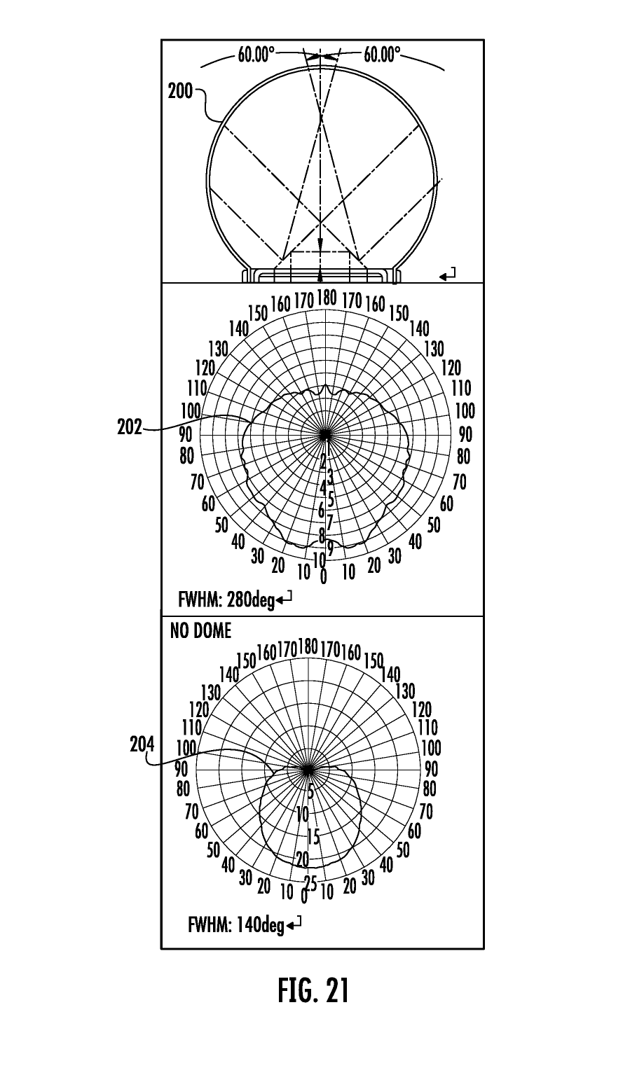

In a presently preferred embodiment as shown in FIG. 21, the light bulb 200 has LEDs angled at approximately 45 degrees and spaced a medium distance apart. The LEDs are mounted on the heat sink at or near the base of the globe. The full width, half maximum light output 202 for a diffuser globe shows that this configuration achieves a 280 FWHM distribution. Without a globe in place of the LEDs, the FWHM curve 204 changes to 140 degrees.

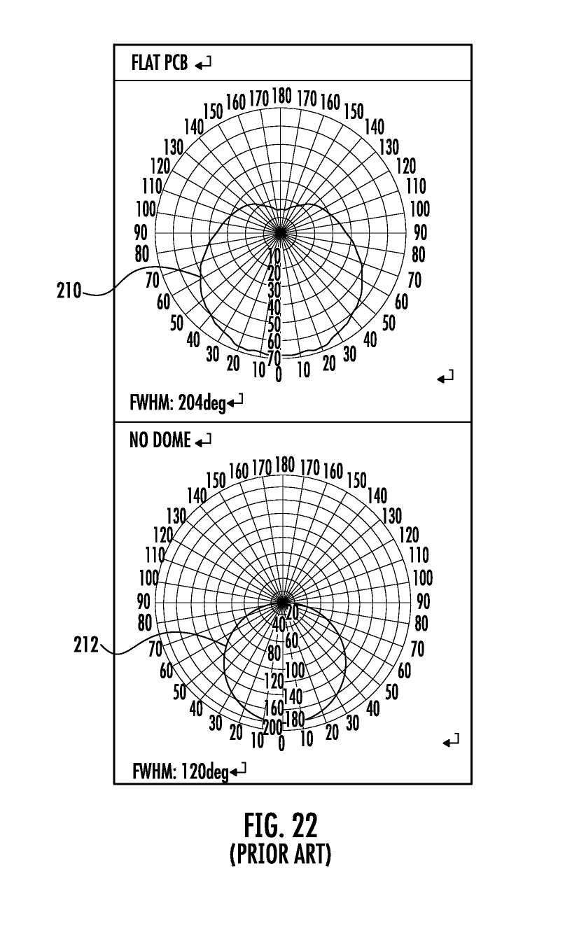

By comparison, the prior art bulbs without angled LEDs and with the LEDs mounted on a flat circuit board have a FWHM curve 210 as shown in FIG. 22 of 204 degrees with a diffuser globe. Without a globe, the light dispersion 212 is 120 degrees.

Each if these results is with the same LED type and characteristics. Variations in the LED used may vary the results. For example, different types of LEDs may be used within the bulb, wherein the LEDs have different dispersion patterns, different spectra, or different light intensities.

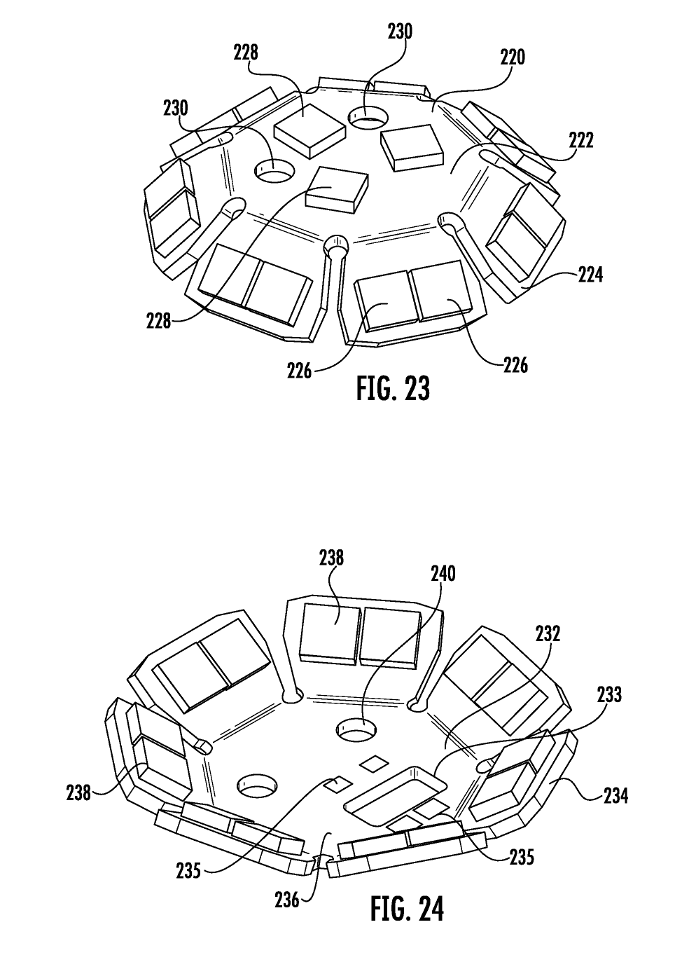

With reference to FIG. 23, a circuit board 220 is provided according to another embodiment. The circuit board 220 has a planar portion 222 at the center and tabs 224 extending outward from the planar portion 222. Each of the tabs 224 has two LEDs 226 mounted thereon. The tabs 224 are bent downward (relative to the illustration) so that the light emitting faces of the LEDs are directed outward from the circuit board, in a generally radial direction. The planar portion 222 of the circuit board 220 has LEDs 228 mounted on it. Embodiments of the circuit board having a ring-shaped planar portion may include LEDs mounted on the planar portion as well. The LEDs 228 direct light from light emitting surfaces perpendicular to the planar portion 222 and supplement the light output from the LEDs on the tabs. The LEDs may thus be mounted only on the tabs or on the tabs and the planar portion. Mounting holes 230 are provided in the circuit board 220 for receiving mounting screws or rivets.

The embodiments shown thus far have included tabs bent to direct the light outward from the circuit board. An alternate embodiment is shown in FIG. 24, wherein the circuit board 232 has tabs 234 bent relative to a planar portion 236 in an upward direction (relative to the illustration). LEDs 238 are mounted on the tabs 234 with their light emitting faces directed inwardly relative to the axis of the printed circuit board 232. Light from the LEDs is dispersed over a wide angle as a result of the LEDs 238 on the bent tabs 234, although the angle of dispersion for the bulb may not be as wide as other embodiment due to the circuit board blocking some of the light of the LEDs. A globe with a dispersive coating or structure may overcome some of the light blocking. Mounting openings 240 are provided in the central planar portion 236 of the circuit board 232 for screws or rivets. An opening 233 is provided for an electrical connector, and solder pads or connecting sites 235 are provided for electrical connection between the connector and the circuit on the circuit board 232.

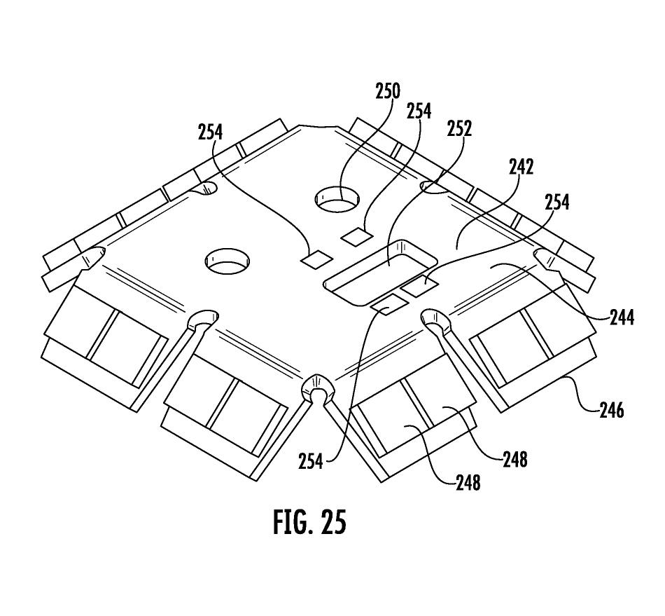

In the embodiment of FIG. 24, light from the LEDs on the tabs is directed inwardly relative to the axis of the circuit board. This is defined as the tabs being bent inwardly. The embodiments of FIGS. 3, 9 and 16, for example, have light from the LEDs directed outwardly relative to the axis of the circuit board, and correspondingly may be defined as the tabs being bent outwardly, regardless of whether the tabs extend inward from a ring-shaped planar portion or extend outward from a central planar portion. FIG. 25 shows an embodiment of a printed circuit board 242 that has a central planar portion 244 from which extend tabs 246 that each carry two LEDs 248. The circuit board 242 is generally square or rectangular with the tabs 246 extending along the sides thereof, rather than radially extending as in embodiment described above. The LEDs direct light outwardly relative to the circuit board as a result of the tabs 246 being bent outwardly, as defined above. A wide light dispersion is achieved without the tabs 246 extending radially outward from the circuit board. The planar portion 244 has mounting openings 250 therein through which are connected the mounting screws or rivets. The opening 252 is provided in the circuit board 242 through which extends a portion of the electrical connector that connects the circuit board to the conductors within the heat sink. Four solder pads or contact sites 254 are provided around the opening 252 on which the electrical connector is seated and to which the electrical connector is electrically connected so that power is supplied to the circuitry of the circuit board 242.

The circuit boards shown herein are without all of the circuit elements that may be required for the operation of the LEDs for the sake of simplicity. The printed circuit boards of actual embodiments may have various circuit elements mounted on the printed circuit boards, as well as leads, traces, solder connections and other aspects of printed circuitry to enable the LEDs to operate, as will be understood by those of skill in the art.

Thus, there is shown and described LED light bulbs having LED elements mounted at angles within the bulb on a circuit board having bent radially projecting tabs or legs, wherein the LED elements face away from the axis of the bulb.

Although other modifications and changes may be suggested by those skilled in the art, it is the intention of the inventors to embody within the patent warranted hereon all changes and modifications as reasonably and properly come within the scope of their contribution to the art.

What is claimed is:

1. A light bulb, comprising:
a lamp base configured for electrical connection to a lamp socket;
a heat sink having a first portion connected to the lamp base and a second portion, the second portion including a mounting surface opposite the first portion, the heat sink including a mounting rim encircling the mounting surface;
a circuit board mounted on the mounting surface, the circuit board including a planar circuit board body mounted in thermal contact with the mounting surface, a plurality of tabs extending from the planar circuit board body, the tabs extending in a plurality of directions from the planar circuit board body, the tabs being disposed at an angle relative to the planar circuit board body;
electrical connecting elements connected between the lamp base and the circuit board;
LEDs mounted on the tabs and electrically connected to the planar circuit board body so as to emit light from the LEDs in a plurality of directions having an outward component relative to the circuit board; and
a globe having a mounting opening affixed to the mounting rim of the heat sink.

2. A light bulb as claimed in claim 1, wherein the circuit board comprises a central planar circuit board body, and wherein the plurality of tabs extend in outward directions from the central planar circuit board body.

3. A light bulb as claimed in claim 1, wherein the circuit board comprises a planar circuit board body having an opening formed therein, and wherein the plurality of tabs extend in inward directions at the opening in the planar circuit board body.

4. A light bulb as claimed in claim 1, wherein the mounting surface is substantially planer, the tabs being disposed at an angle to the planar circuit board body so as to be free of the mounting surface.

5. A light bulb as claimed in claim 1, wherein the mounting surface of the heat sink includes a raised central portion and angled segments adjacent the raised central portion, the tabs of the circuit board being mounted in thermal contact with the angled segments.

6. A light bulb as claimed in claim 5, wherein the planar circuit board body is mounted on the raised central portion of the heat sink.

7. A light bulb as claimed in claim 6, wherein the tabs extend radially outward from the planar circuit board body.

8. A light bulb as claimed in claim 5, wherein the planar circuit board body encircles the raised central portion of the heat sink.

9. A light bulb as claimed in claim 8, wherein the tabs extend radially inward from the planar circuit board body.

10. A light bulb as claimed in claim 1, wherein the planar circuit board body and the tabs disposed at angles to the planar circuit board body are formed of a single piece circuit board.

11. A light bulb as claimed in claim 1, wherein the plurality of tabs are each of a same size and shape.

12. A light bulb as claimed in claim 1, wherein at least one of the plurality of tabs are of differing at least one of size and shape than others of the plurality of tabs.

13. A light bulb as claimed in claim 1, wherein each of the plurality of tabs is bent as a same angle relative to the planar circuit board body.

14. A method of making an LED light bulb, comprising:
mounting a plurality of LEDs on radially projecting tabs of a circuit board, the circuit board having a circuit board body;
bending the tabs at an angle to the circuit board body so that the LEDs face in a direction having a outward component relative to the circuit board;
mounting a circuit board on a heat sink within a globe of the LED light bulb, the circuit board body being mounted in thermal contact with the heat sink; and
mounting a globe over the LEDs and circuit board.

15. A method of distributing light from an LED light bulb, comprising:
directing light output by a plurality of LEDs in a plurality of substantially radially outward directions relative to an axis of the light bulb, the plurality of LEDs being mounted on a single piece circuit board on angled tabs extending radially from a body of the circuit board; and
electrically connecting the plurality of LEDs to power via the single circuit board.

16. An LED light bulb, comprising:
a power supply connection;
a heat sink having a mounting surface;
a circuit board having a planar body mounted in thermal contact with the mounting surface of the heat sink, the circuit board having a plurality of tabs extending radially from the planar body, the tabs being bent at an angle to the planar body;
a plurality of LEDs mounted on the tabs so as to have light emitting faces of the LEDs directed in directions having substantially radially outward components relative to an axis of the circuit board;
the power supply connection being connected to the circuit board and to the LEDs to power the LEDs; and
a globe mounted over the LEDs.

17. A light bulb as claimed in claim 16, wherein the planar body of the circuit board is ring-shaped and the tabs extend radially inward.

18. A light bulb as claimed in claim 16, wherein the planar body of the circuit board is a central circuit board portion and the tabs extend radially outward.

19. A light bulb as claimed in claim 16, wherein at least one LED is mounted on the planar body of the circuit board.
